(19) United States
(12) Patent Application Publication
(10) Pub. No.: US 2015/0121987 A1
(43) Pub. Date: May 7, 2015

(54) LIFT PIN AND DIE

(71) Applicants: Thomas J. Flynn, Roscoe, IL (US); Vincent E. Messina, Wales Township, MI (US); James K. Horian, Fairhaven, MI (US)

(72) Inventors: Thomas J. Flynn, Roscoe, IL (US); Vincent E. Messina, Wales Township, MI (US); James K. Horian, Fairhaven, MI (US)

(21) Appl. No.: 14/069,459

(22) Filed: Nov. 1, 2013

(51) Int. Cl. B66C 1/66; B21D 37/06; B66D 1/60

(52) U.S. Cl. CPC B66C 1/66; B66D 1/60; B21D 37/06
USPC 72/481.8; 254/266; 411/366.1

(57) ABSTRACT

A lift pin may include a head, a retainer and a shaft disposed between the head and the retainer. The shaft may include first and second portions and a step disposed therebetween. The first and second portions may include first and second diameters, respectively. The first diameter may be larger than the second diameter. The head may be disposed on an end of the first portion opposite the step and may include a third diameter that is larger than the first diameter. The second portion may be disposed between the first portion and the retainer. The retainer may be attached to the shaft and may be movable in a radial direction relative to the shaft between first and second positions.

### FIELD

The present disclosure relates to a lift pin and a die.

### BACKGROUND

Stamping dies and other tools may include removable lift pins to which chains and/or cables may be attached in order to lift and/or transport the die or other tool. Such lift pins and dies may be designed in a manner that allows the lift pins to be inserted into the die or other tool only in a predetermined manner.

### SUMMARY

The present disclosure provides an assembly that may include a lift pin and a tool. The lift pin may include a shaft, a head and a retainer. The shaft may include first, second and third portions having first, second and third diameters, respectively. The second diameter may be larger than the third diameter and smaller than the first diameter. The second portion may be disposed between the first and third portions. The head may be disposed on an end of the first portion and may include a fourth diameter that is larger than the first diameter. The retainer may be disposed about the third portion and may be movable relative to the third portion between a concentric position and an eccentric position. The tool may include a body and first and second studs extending from the body. The first stud may include a first bore sized to receive the first portion of the shaft. The second stud may include a second bore having first and second inner diametrical surfaces and a step between the first and second inner diametrical surfaces. The first inner diametrical surface may be sized to receive the first portion of the shaft. The second inner diametrical surface may be sized to receive the second portion of the shaft and prevent passage of the first portion of the shaft therethrough.

In some embodiments, the assembly may include first and second bushings received in the first and second studs. The first and second bushings may define the first and second bores, respectively.

In some embodiments, the first and second studs may be cast around the first and second bushings.

In some embodiments, a diameter of the second inner diametrical surface of the second bore may be smaller than the first diameter of the first portion of the shaft.

In some embodiments, a diameter of the first bore may be smaller than the fourth diameter of the head of the lift pin.

In some embodiments, the first and second studs may be spaced apart from each other.

In some embodiments, the lift pin may include a spring disposed between the retainer and the third portion and biasing the retainer toward the eccentric position.

In some embodiments, the spring may include a spiral shape.

In some embodiments, the lift pin may include a nut threadably engaging the third portion and restricting axial movement of the retainer relative to the shaft.

In some embodiments, the tool may be a stamping die.

In some embodiments, the assembly may include a hoist and a chain extending from the hoist and engaging the first portion of the shaft between the first and second studs.

In another form, the present disclosure provides a lift pin that may include a head, a retainer and a shaft disposed between the head and the retainer. The shaft may include first and second portions and a step disposed therebetween. The first and second portions may include first and second diameters, respectively. The first diameter may be larger than the second diameter. The head may be disposed on an end of the first portion opposite the step and may include a third diameter that is larger than the first diameter. The second portion may be disposed between the first portion and the retainer. The retainer may be attached to the shaft and may be movable in a radial direction relative to the shaft between first and second positions.

In some embodiments, the shaft may include a third portion having a fourth diameter that may be smaller than the second diameter.

In some embodiments, the retainer may be disposed about the third portion and may be concentric with the third portion in the first position and eccentric relative to the third portion in the second position.

In some embodiments, the lift pin may include a spring disposed between the retainer and the third portion and biasing the retainer toward the second position.

In some embodiments, the spring may include a spiral shape.

In some embodiments, the lift pin may include a nut threadably engaging the third portion and restricting axial movement of the retainer relative to the shaft.

In some embodiments, the lift pin may be a part of an assembly including first and second bushings. The first bushing may include a first bore sized to receive the first portion of the shaft. The second bushing may include a second bore having first and second inner diametrical surfaces and a step between the first and second inner diametrical surfaces. The first inner diametrical surface may be sized to receive the first portion of the shaft. The second inner diametrical surface may be sized to receive the second portion of the shaft and may prevent passage of the first portion of the shaft therethrough.

In some embodiments, a diameter of the second inner diametrical surface of the second bore may be smaller than the first diameter of the first portion of the shaft.

In some embodiments, a diameter of the first bore may be smaller than the third diameter of the head of the lift pin.

In some embodiments, the assembly may include a die, a hoist and a chain. The die may include first and second spaced apart studs engaging the first and second bushings, respectively. The chain may extend from the hoist and engage the first portion of the shaft between the first and second studs.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic representation of a hoist and die with lift pins according to the principles of the present disclosure;

FIG. 2 is a perspective view of a pair of studs of the die and one of the lift pins of FIG. 1;

FIG. 3 is an exploded perspective view of the studs and lift pin of FIG. 2;

FIG. 4 is a cross-sectional view of the studs and lift pin of FIG. 2; and

FIG. 5 is a partial cross-sectional view of a prior-art die and a prior-art lift pin.

### DETAILED DESCRIPTION

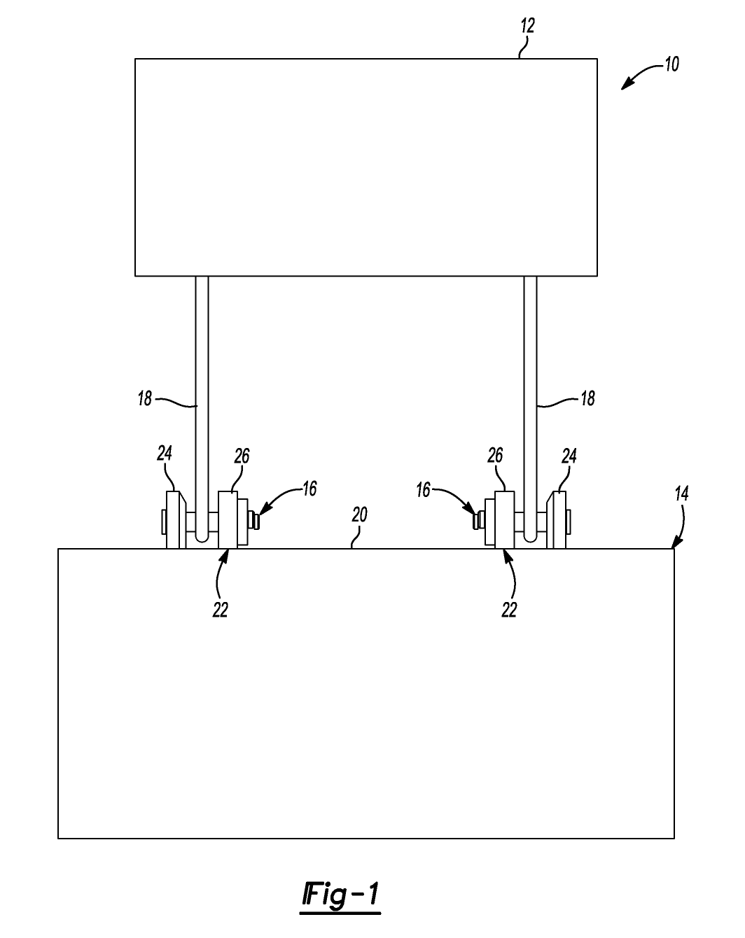

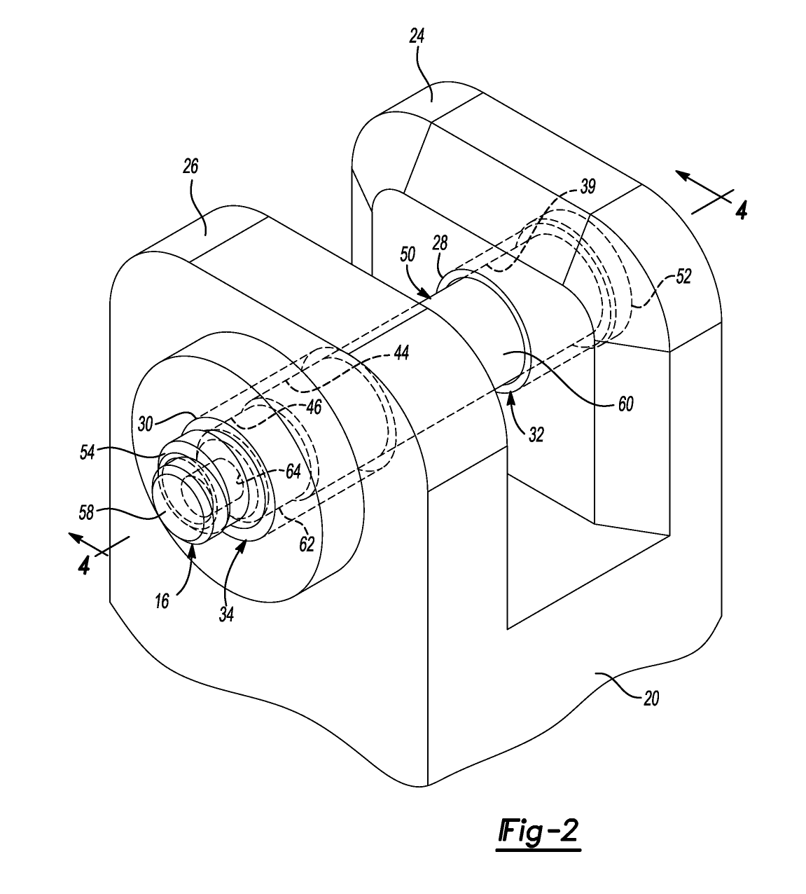

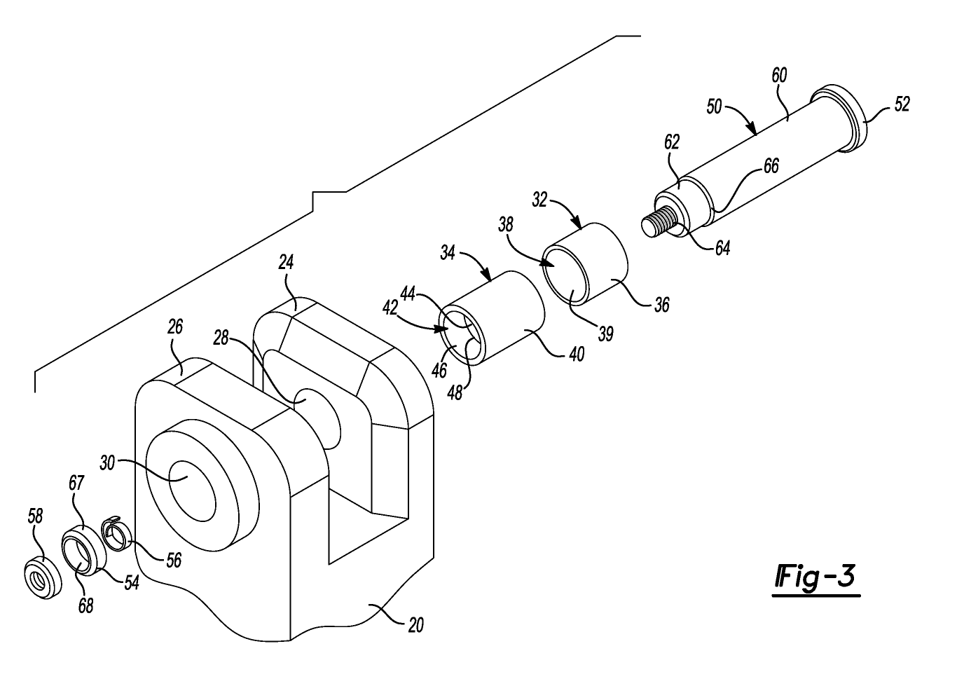

In an exemplary embodiment and with reference to FIGS. 1-4, an assembly 10 is provided that may include a hoist 12, a tool 14, one or more lift pins 16 and one or more cables or chains 18. The lift pins 16 may be removably installed in the tool 14 and the chains 18 may be attached to the lift pins 16 to allow the hoist 12 to lift and/or transport the tool 14. As will be subsequently described, the tool 14 and the lift pins 16 are configured such that the lift pins 16 can be installed into the tool 14 only in a predetermined manner.

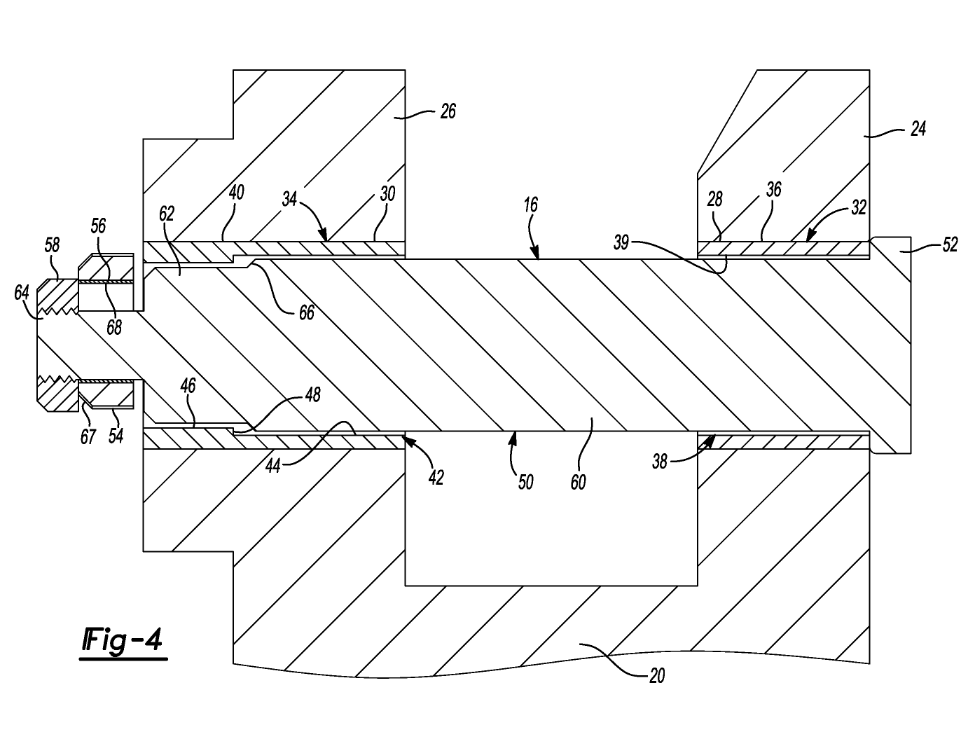

The tool 14 may be a stamping die or any other type of die or tool, such as a casting or injection-molding die or a workpiece fixture, for example. In some embodiments, the tool 14 may be cast or otherwise formed from a metallic material and may include a body 20 and one or more attachment interfaces 22. Each of the attachment interfaces 22 may include a first lug or stud 24 and a second lug or stud 26. The first and second studs 24, 26 may include first and second apertures 28, 30, respectively, extending therethrough. As shown in FIG. 4, the first and second apertures 28, 30 may be coaxially aligned with each other.

The first and second apertures 28, 30 may receive first and second liners or bushings 32, 34, respectively, therein. The first and second bushings 32, 34 may be pressed into or cast into the first and second apertures 28, 30. The first bushing 32 may include an outer diametrical surface 36 and a first bore 38. The outer diametrical surface 36 may include a generally constant diameter. The first bore 38 may include an inner diametrical surface 39 with a generally constant diameter. The second bushing 34 may include an outer diametrical surface 40 and a second bore 42. The outer diametrical surface 40 may include a generally constant diameter. The second bore 42 may include a first inner diametrical surface 44, a second inner diametrical surface 46 and a step 48 disposed between the first and second inner diametrical surfaces 44, 46. The inner diametrical surface 39 of the first bushing 32 and the first inner diametrical surface 44 of the second bushing 34 may have substantially equal diameters. The second inner diametrical surface 46 of the second bushing 34 may have a diameter that is smaller than the diameter of the first inner diametrical surface 44.

While the outer diametrical surfaces 36, 40 of the first and second bushings 32, 34 are described above as having constant diameter, in some embodiments, the one or more grooves or other surface features may be formed on or in the outer diametrical surfaces 36, 40 to facilitate retention of the bushings 32, 34 in the apertures 28, 30.

While the first and second studs 24, 26 are described above as including the first and second bushings 32, 34, in some embodiments, the studs 24, 26 may not include the bushings 32, 34. Instead, the studs 24, 26 could include the first and second bores 38, 42 with inner diametrical surfaces 39, 44, 46 formed directly therein.

Each of the lift pins 16 may engage a corresponding one of the attachment interfaces 22 of the tool 14. That is, each lift pin 16 may be received in the first and second bores 38, 42 of the first and second studs 24, 26. Each lift pin 16 may include a shaft 50, a head 52, a retainer 54, a spring 56 and a nut 58. The shaft 50 may include coaxial first, second and third portions 60, 62, 64. The first portion 60 may be disposed between the head 52 and the second portion 62. A step 66 may separate the first and second portions 60, 62. The first portion 60 may include a diameter that is larger than a diameter of the second portion 62. The diameter of the first portion 60 is larger than the diameter of the second inner diametrical surface 46 of the second bushing 34 and is equal to or smaller than the diameter of the first inner diametrical surface 44 of the second bushing 34. The third portion 64 may extend from the second portion 62 in a direction opposite the first portion 60. The third portion 64 may threadably engage the nut 58. In some embodiments, the head 52 and the first, second and third portions 60, 62, 64 may be integrally formed as a unitary body. In some embodiments, one or more of the head 52 and the first, second and third portions 60, 62, 64 may be separate and discrete components that are welded, threadably fastened and/or otherwise joined together.

The retainer 54 may be an annular member disposed around the third portion 64 between the nut 58 and the second portion 62. The retainer 54 may include a tapered axial end 67. The spring 56 may be disposed radially between the retainer 54 and the third portion 64 in a bore 68 of the retainer 54 through which the third portion 64 extends. The spring 56 may be a spiral shaped member or any other suitable spring member. The retainer 54 may be movable relative to the third portion 64 in a radial direction between a first position in which the retainer 54 is concentric with the shaft 50 and a second position in which the retainer is eccentric relative to the shaft 50. The spring 56 may bias the retainer 54 toward the second position.

To install the lift pin 16 into the attachment interface 22, the end of the lift pin 16 having the retainer 54 may be inserted through the first bore 38 in the first stud 24 and then through the second bore 42 in the second stud 26. The lift pin 16 may continue to be slid through the first and second bores 38, 42 in this direction until the retainer 54 has completely exited the second bore 42 and/or until the head 52 contacts the first stud 24. When the retainer 54 exits the second bore 42, the spring 56 may urge the retainer 54 into the eccentric position so the retainer 54 cannot be freely slid back through the second bore 42 and so the lift pin 16 cannot be freely removed from the attachment interface 22. In order to remove the lift pin 16 from the attachment interface 22, the retainer 54 would need to be held in the concentric position so that the retainer 54 could be slid back through the second bore 42.

The structure of the lift pin 16 and the bores 38, 42 allow the lift pin 16 to be inserted fully inserted into the attachment interface 22 in the manner described above while also preventing the lift pin 16 from being installed into the attachment interface 22 by inserting the lift pin 16 through the bores 38, 42 in the opposite direction. That is, the lift pin 16 cannot be installed in the attachment interface 22 by first inserting the lift pin 16 through the second bore 42 and then through the first bore 38. Because the first portion 60 of the shaft 50 of the lift pin 16 has a larger diameter than the diameter of the second inner diametrical surface 46 of the second bushing 34, the lift pin 16 is prevented from being inserted through the bores 38, 42 in a direction opposite the direction shown in FIG. 4.

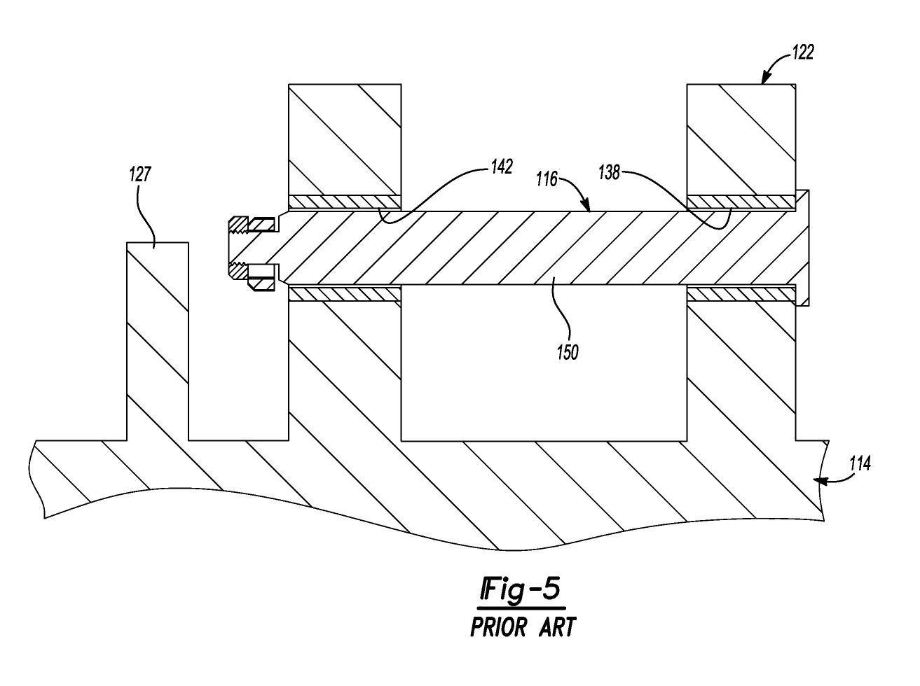

FIG. 5 depicts a prior-art die 114 and a prior-art lift pin 116. The die 114 includes an attachment interface 122 having bores 138, 142 that receive the lift pin 116. The bores 138, 142 have a constant diameter and slidably receive a constant-diameter portion of a shaft 150 of the lift pin 116. The prior-art die 114 includes a blocker stud 127 proximate the attachment interface 122 that allows the lift pin 116 to be installed in the attachment interface 122 by inserting the lift pin 116 through the first bore 138 and then through the second bore 142. The blocker stud 127 prevents the lift pin 116 from being inserted bores 138, 142 in the opposite direction (i.e., through the second bore 142 first, and then through the first bore 138).

Contrary to the depicted prior art, the construction of the tool 14 and lift pin 16 depicted in FIGS. 1-4 allows the tool 14 to be formed without the blocker stud 127 while still only allowing the lift pin 16 to be installed in the attachment interface 22 in the manner shown in FIG. 4. Eliminating the blocker stud 127 may simplify the design of the tool 14 and may allow for more design flexibility. It will be appreciated, however, that the lift pin 16 and bushings 32, 34 could be used with a die or other tool that includes a blocker stud proximate the attachment interface.

What is claimed is:

1. An assembly comprising:
a lift pin including a shaft, a head and a retainer, the shaft including first, second and third portions having first, second and third diameters, respectively, the second diameter being larger than the third diameter and smaller than the first diameter, the second portion disposed between the first and third portions, the head disposed on an end of the first portion and having a fourth diameter that is larger than the first diameter, the retainer disposed about the third portion and movable relative to the third portion between concentric and eccentric positions; and
a tool including a body and first and second studs extending from the body, the first stud including a first bore sized to receive the first portion of the shaft, the second stud including a second bore having first and second inner diametrical surfaces and a step between the first and second inner diametrical surfaces, the first inner diametrical surface being sized to receive the first portion of the shaft, the second inner diametrical surface being sized to receive the second portion of the shaft and prevent passage of the first portion of the shaft therethrough.

2. The assembly of claim 1, further comprising first and second bushings received in the first and second studs, wherein the first and second bushings define the first and second bores, respectively.

3. The assembly of claim 2, wherein the first and second studs are cast around the first and second bushings.

4. The assembly of claim 1, wherein a diameter of the second inner diametrical surface of the second bore is smaller than the first diameter of the first portion of the shaft.

5. The assembly of claim 1, wherein a diameter of the first bore is smaller than the fourth diameter of the head of the lift pin.

6. The assembly of claim 1, wherein the first and second studs are spaced apart from each other.

7. The assembly of claim 1, wherein the lift pin includes a spring disposed between the retainer and the third portion and biasing the retainer toward the eccentric position.

8. The assembly of claim 7, wherein the spring has a spiral shape.

9. The assembly of claim 1, wherein the lift pin includes a nut threadably engaging the third portion and restricting axial movement of the retainer relative to the shaft.

10. The assembly of claim 1, wherein the tool is a stamping die.

11. The assembly of claim 1, further comprising a hoist and a chain extending from the hoist and engaging the first portion of the shaft between the first and second studs.

12. A lift pin comprising a head, a retainer and a shaft disposed between the head and the retainer, the shaft including first and second portions and a step disposed therebetween, the first and second portions having first and second diameters, respectively, the first diameter being larger than the second diameter, the head disposed on an end of the first portion opposite the step and having a third diameter that is larger than the first diameter, the second portion disposed between the first portion and the retainer, the retainer attached to the shaft and movable in a radial direction relative to the shaft between first and second positions.

13. The lift pin of claim 12, wherein the shaft includes a third portion having a fourth diameter that is smaller than the second diameter.

14. The lift pin of claim 13, wherein the retainer is disposed about the third portion and is concentric with the third portion in the first position and eccentric relative to the third portion in the second position.

15. The lift pin of claim 14, further comprising a spring disposed between the retainer and the third portion and biasing the retainer toward the second position.

16. The lift pin of claim 15, wherein the spring has a spiral shape.

17. The lift pin of claim 15, further comprising a nut threadably engaging the third portion and restricting axial movement of the retainer relative to the shaft.

18. An assembly comprising the lift pin of claim 12 and first and second bushings, the first bushing including a first bore sized to receive the first portion of the shaft, the second bushing including a second bore having first and second inner diametrical surfaces and a step between the first and second inner diametrical surfaces, the first inner diametrical surface being sized to receive the first portion of the shaft, the second inner diametrical surface being sized to receive the second portion of the shaft and prevent passage of the first portion of the shaft therethrough.

19. The assembly of claim 18, wherein a diameter of the second inner diametrical surface of the second bore is smaller than the first diameter of the first portion of the shaft, and wherein a diameter of the first bore is smaller than the third diameter of the head of the lift pin.

20. The assembly of claim 19, further comprising a die, a hoist and a chain, the die including first and second spaced apart studs engaging the first and second bushings, respectively, the chain extending from the hoist and engaging the first portion of the shaft between the first and second studs.
